(19) United States
(12) Patent Application Publication
(10) Pub. No.: US 2018/0137026 A1
(43) Pub. Date: May 17, 2018

(54) Service Test Validation Framework

(71) Applicant: PAYPAL, INC., San Jose (JP)

(72) Inventors: Sabarirajan Jeeva, Santa Clara, CA (US); Nir Szilagyi, San Jose, CA (US); Vijayalakshmi Dharmalingam, Santa Clara, CA (US)

(21) Appl. No.: 15/353,457

(22) Filed: Nov. 16, 2016

(51) Int. Cl. G06F 11/36

(52) U.S. Cl. CPC G06F 11/3608; G06F 11/3664

(57) ABSTRACT

The systems and methods that validate data are provided. The systems and methods include a validation module which is a single solution for validating data in multiple services. The validation module is incorporated into a service. The validation module is provided with a configuration file that includes a test case identifier and with test case data that corresponds to the test case identifier. The validation module hijacks a request that is processed by a service and identifies a data element in the request that corresponds to the test case identifier in the configuration file. The validation module then validates data in the request against test case data that corresponds to the test case identifier.

### TECHNICAL FIELD

The disclosure generally relates to validating data, and more specifically to a validation module that validates different types of data from different services without adding additional code to the services or the validation module.

### BACKGROUND

Conventional validation systems are application and service specific. This means a validation system is designed to validate a particular application or service and that multi-service or application systems are validated using hundreds of separate validation systems. Moreover, conventional validation systems may require services and applications to be modified with additional source code that is activated during validation.

Also, when services or applications are upgraded, the corresponding conventional validation systems may also require upgrades in order to properly validate data that passes through the services or applications. In addition to upgrading the conventional validation systems, test data and testing scenarios may also require changes that reflect the service and application upgrades.

Further, when multiple conventional validation systems validate data that travels across multiple services or applications, quality assurance personal familiar with each different conventional validation system and services or applications may be involved. This results in multiple persons being involved in the validation process.

The above generates human and technological overhead which causes conventional validation systems to be expensive to use and difficult to maintain.

### BRIEF DESCRIPTION OF THE DRAWINGS

FIG. 1 is an exemplary system where embodiments can be implemented.

FIG. 2 is a block diagram of an environment that includes a validation module, according to an embodiment.

FIG. 3 is a block diagram of a validation module, according to an embodiment.

FIG. 4 is a flowchart of a method for validating data, according to an embodiment.

FIG. 5 is a block diagram of a computer system suitable for implementing one or more components in FIGS. 1-4, according to an embodiment.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Systems and methods for validating data with a validation module are provided. Unlike conventional validation systems that are application or service specific, the validation module is incorporated or “plugged” into a service or application that requires validation. Once the validation module is “plugged” in, the validation module diverts requests to/from the service or application and validates the data in the requests.

In an embodiment, to validate data in the requests, the validation module is coupled to a configuration file and test case data. The configuration file includes one or more test case identifiers (IDs). The one or more test case IDs may be data elements in the request. These data elements may be used to process the request by the service or application and need not be specific to the validation module. When the data elements in the request match one or more test case IDs in the configuration file, the validation module validates the data in the request against the test case data.

In another embodiment, the configuration file may include one or more rules that are associated with the test case ID. When the data elements in the request match one or more test case IDs in the configuration file, the validation module may use the one or more rules that are associated with the test case IDs to validate data in the request against the test case data.

Once the validation module validates the request, the validation module generates a validation message. The validation message indicates whether the validation was a success or a failure. The validation message may be displayed on a display screen of a computing device.

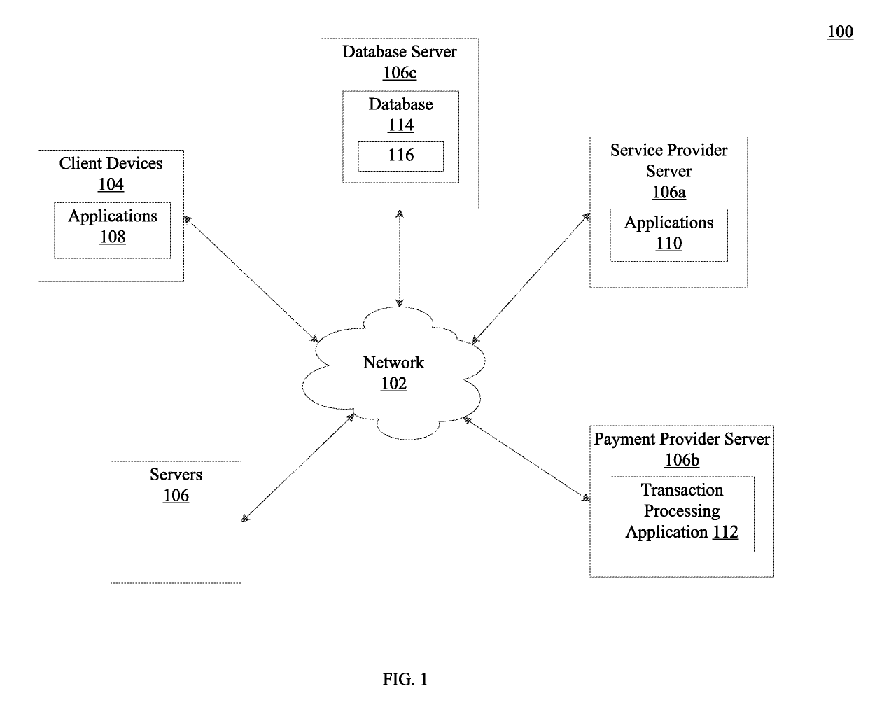

FIG. 1 is an exemplary system 100 where embodiments can be implemented. System 100 includes a network 102, client devices 104, and servers 106.

In an embodiment, network 102 may be implemented as a single network or a combination of multiple networks. For example, in various embodiments, network 102 may include the Internet or one or more intranets, landline networks, wireless networks, and/or other appropriate types of networks. Network 102 may be a small scale communication network, such as a private or local area network, or a larger scale network, such as a wide area network, accessible by the various components of system 100.

In an embodiment, client devices 104 may be portable and non-portable electronic devices under control of a user and configured to transmit, receive, and manipulate data received from different servers 106 over network 102. Example client devices 104 include desktop computers, laptop computers, tablets, smartphones, wearable computing devices, eyeglasses that incorporate computing devices, implantable computing devices, etc.

Client devices 104 may include one or more applications 108. Applications 108 may be pre-installed on the client devices 104, installed on the client devices 104 using portable memory storage devices, such as compact disks or thumb-drives, or be downloaded to the client devices 104 from servers 106. Applications 108 may execute on the client devices 104 and receive instructions and data from a user, and send and transmit instructions and data to servers 106.

In an embodiment, applications 108 may provide various services to users using client devices 104. Example applications 108 installed on client devices 104 may be payment transaction applications. Payment transaction applications may be configured to transfer money world-wide, receive payments for goods and services, manage money spending, etc. Further, applications 108 may be under an ownership or control of a payment service provider, such as PAYPAL®, Inc. of San Jose, Calif., USA, a telephonic service provider, a social networking service provider, and/or other service providers. In an embodiment, applications 108 may also be analytics applications. Analytics applications perform business logic, provide services, and measure and improve performance of services and functions of other applications that execute on client devices 104 based on current and historical data. In another embodiment, applications 108 may be security applications for implementing client-side security features, programmatic client applications for interfacing with appropriate application programming interfaces (APIs) over network 102. In yet another embodiment, applications 108 may be communication applications, such as email, texting, voice, and instant messaging applications that allow a user to send and receive emails, calls, texts, and other notifications through network 102. In yet another embodiment, applications 108 may be location detection applications, such as a mapping, compass, and/or global positioning system (GPS) application. In yet another embodiment, applications 108 may be social networking applications and/or merchant applications. In yet another embodiment, applications 108 may be service applications that permit a user of client device 104 to receive, request and/or view information for products and/or services, and also permit the user to purchase the selected products and/or services.

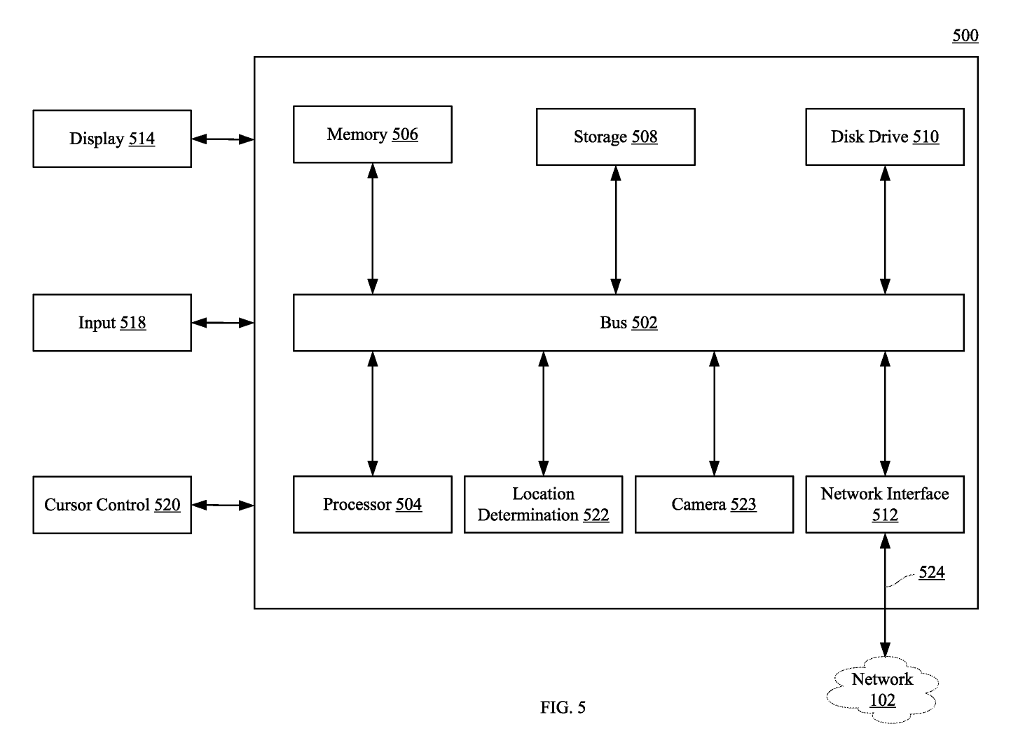

In an embodiment, applications 108 may utilize numerous components included in client devices 104 to display, receive input, store and transmit data, and communicate other client devices 104 and servers 106 over network 102. Example components are discussed in detail in FIG. 5.

In an embodiment, server 106 may be a computer device or a software program that provides functionality to other devices in network 102, such as client devices 104. In an embodiment, server 106 may serve multiple client devices 104. For example, server 106 may provide services and/or data to client devices 104, store data on behalf of client devices 104, etc. Example servers 106 may include service provider servers, payment provider servers, database servers, file servers, mail servers, print servers, application servers, game servers, etc. There may be hundreds or thousands of servers connected to network 102. Example service provider server 106a, payment provider server 106b, and database server 106c are described below.

In an embodiment, service provider server 106a may provide services to multiple applications 108 that execute on client devices 104. Service provider server 106a may also be maintained by a service provider, such as PAYPAL®, a telephonic service provider, social networking service, and/or other service providers.

In an embodiment, service provider server 106a executes applications 110. Applications 110 may receive, process, and transmit data for user requested products and/or services transmitted from client devices 104. Thus, applications 110 may be financial services applications configured to transfer money world-wide, receive payments for goods and services, manage money spending, etc. In an embodiment, applications 110 may also be security applications configured to implement client-side security features or programmatic client applications for interfacing with appropriate application programming interfaces (APIs) over network 102. In another embodiment, applications 110 may be communication applications that perform email, texting, voice, and instant messaging functions that allow a user to send and receive emails, calls, texts, and other notifications over network 102. In yet another embodiment, applications 110 may be location detection applications, such as a mapping, compass, and/or GPS applications. In yet another embodiment, applications 110 may also be incorporated into social networking applications and/or merchant applications.

In an embodiment, when applications 108 transmit requests and/or data to applications 110, applications 110 process the requests and data. In a further embodiment, applications 110 may request payment from a user using application 108 to process the requests. For example, application 110 may use payment provider server 106b to process the payment requests. The payment provider server 106b may receive payment requests from application 110 that causes the payment provider server 106b to transfer funds of a user using application 108 to service provider associated with the service provider server 106a.

In an embodiment, payment provider server 106b includes one or more transaction or payment processing applications 112. Payment processing applications 112 facilitate transfer of funds between one or more parties, or applications, such as applications 108 and 110. In an embodiment, payment processing applications 112 may be configured to receive information from one or more applications 108, 110 executing on client devices 104 and/or service provider server 106a for processing and completion of financial transactions. Financial transactions may include financial information corresponding to user debit/credit card information, checking account information, a user account (e.g., payment account with a payment provider server 106b), or other payment information. Transaction processing application 112 may complete the financial transaction for the purchase request by providing payment to application 110 executing on service provider server 106b. In various embodiments, transaction processing application 112 may provide transaction histories, including receipts, to client device 104 in order to provide proof of purchase for an item and/or service.

In an embodiment, in order to complete financial transactions (or other transactions), payment provider server 106b (or another server 106) may store transactions in database 114. Database 114 may be a collection of tables, schemas, queries, views, etc. that are stored in memory suitable to store large quantities of data, such as a memory described in FIG. 5. In an embodiment, database 114 may be hosted on database server 106c and is accessible to applications 108, 110, and 112 via messages in a form of queries. In an embodiment, payment provider server 106b may establish user accounts 116 in database 114. Each user account 116 may be associated with one or more users using application 108 with payment provider server 106b to facilitate payment for goods and/or services offered by applications 110. User accounts 116 may include user information, such as name, address, birthdate, payment/funding information, travel information, additional user financial information, and/or other desired user data.

In an embodiment, applications 108, 110, and/or 112 may comprise one or more services. These services may overlap among applications 108, 110, and/or 112 or be specific to one or more of applications 108, 110, and/or 112. Further, applications 108, 110, and/or 112 or services within these applications may be upgraded, updated, replaced, deleted, etc. When applications 108, 110, and/or 112 or services change, the data that passes through the new services or applications may be validated. The validation may be implemented within each application or service and ensures that the components within the application or service act on the data as intended. Additionally, the validation may also be implemented externally to the application or service. The external validation validates data that is received and transmitted to/from the service or application and ensures that the changes to application or service affect other services or applications in the overall system, such as the system described in FIG. 1.

In another embodiment, data that passes through applications 108, 110, and/or 112 and services may also be validated for fraud. In this case, the validation may determine whether a fraudulent transaction occurs in the system described in FIG. 1.

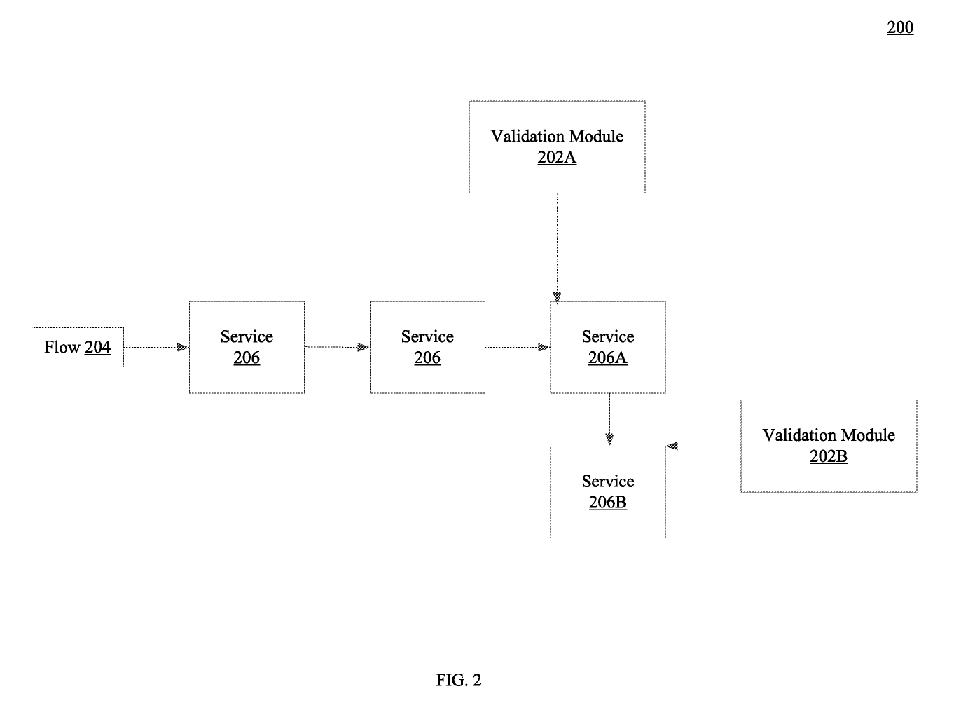

To validate data, a validation module, such as the one described in FIG. 2, below, may be incorporated into client devices 104 and servers 106. Unlike conventional validation modules, the validation module is not application or service specific, but may be configured to validate data from or within multiple services and applications, and without making code changes in applications 108, 110, or 112, services or validation module.

FIG. 2 is a block diagram 200 of an environment that includes a validation module, according to an embodiment. Block diagram 200 illustrates an exemplary system that may process a transaction. The system includes multiple services 206 that may be included in one or more applications, such as applications 108, 110, or 112 and a flow 204 that was generated from one of the transactions that was initiated by and is processed by one or more applications 108, 110, or 112, in an embodiment. Example flow 204 may include a transaction for account creation, a transaction between an entity and a service provider for goods or services (with or without a third party payment provider), a transaction that lists goods or services, a transaction that lists account information, etc. As illustrated in FIG. 2, flow 204 may pass through different services 206.

In an embodiment, block diagram 200 includes a validation module 202. Exemplary validation modules are validation modules 202A or 202B. Validation modules 202A and 202B may be different instances of the same validation module 202 that validates data for different services 206, such as service 206A and 206B, respectively.

As illustrated in FIG. 2, validation module 202 receives data from flow 204. In an embodiment, flow 204 may include multiple data elements that store data that is included in flow 204. As each flow 204 is being processed by services 206, flow 204 may include hundreds of different data elements that are added, modified, deleted, etc., by services 206. As different services 206 are being updated, new services 206 are added to the system and old services 206 are deleted, different data elements of flow 204 may be affected.

In an embodiment, validation module 202 validates data stored in the data elements of flow 204 to ensure that changes to the services 206 do not negatively impact a transaction and that flow 204 does not include unsuitable data, such as fraudulent data, incorrect data, corrupted data, and/or empty data. As discussed above, validation module 202 may validate flow 204 without making code changes within services 206 or within validation module 202. To validate flow 204 between different services 206, validation module 202 may be a software application. In a further embodiment, validation module 202 may be a “plug-in” that may be incorporated into service 206. A “plug-in” may be a software module that enables customization to service 206, such as, adding a validation feature that validates data in flows 204 that pass through service 206. In an embodiment, validation module 202 or one or more components or subcomponents thereof may also be designed using “AspectJ” which is an aspect-oriented programming (AOP) extension created for Java programming language, though the implementation is not limited to this embodiment. Once validation module 202 is “plugged” into one of services 206, validation module 202 may selectively re-route flow 204 from service 206 and into validation module 202 and validate the data.

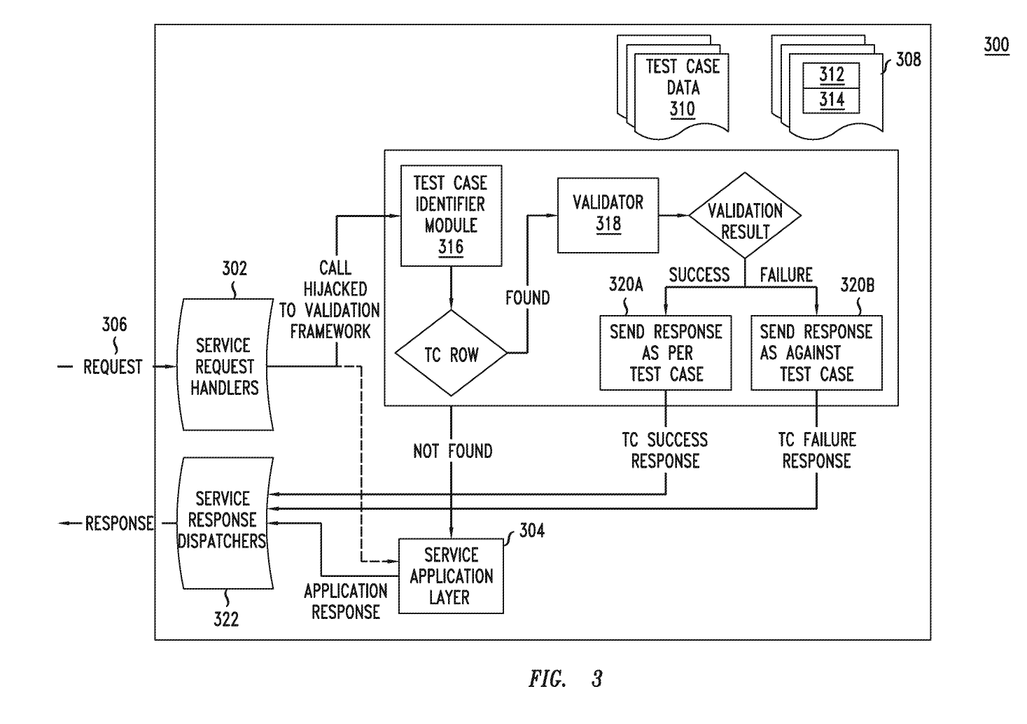

FIG. 3 is a block diagram 300 of a validation module 202 according to an embodiment. As illustrated in FIG. 3, validation module 202 may be inserted in service 206 between a service request handler 302 and service application layer 304. In an embodiment, service request hander 302 may receive flow 204 from other services 206 as shown in FIG. 2. Depending on whether validation module 202 is configured to validate flow 204, service request handler 302 may pass flow 204 to the service application layer 304 which processes flow 204 or validation module 202 which validates the data in flow 204.

In an embodiment, flow 204 that is received by a particular service 206 is referred to as a request 306. Request 306 may include one or more data elements associated with flow 204. In an embodiment, validation module 202 may be incorporated or “plugged” into service 206 to validate whether request 306 includes accurate data elements prior to being transmitted to the service application layer 304 or to determine whether request 306 includes unsuitable data, such as fraudulent data, incorrect data, corrupted data, empty data, etc.

In an embodiment, when the service request handler 302 receives request 306 and before the service request handler 302 passes request 306 to the service application layer 304, validation module 202 “hijacks” request 306. This means that the validation module 202 may re-route request 306 that service request handler 302 would have otherwise forwarded to the service application layer 304 for validation.

In an embodiment, validation module 202 may be coupled to a configuration file 308 and test case data 310. Configuration file 308 and test case data 310 may be stored in one of the memories associated with the computing device that hosts or is communicatively coupled to validation module 202, and may be described in detail in FIG. 5. In an embodiment, configuration file 308 includes a test case ID 312. In a further embodiment, the test case ID 312 may be associated with one or more rules 314. Validation module 202 may use rules 314 to validate different testing scenarios of how service 206 may process the request 306 or different scenarios for validating data elements in request 306 to determine that request 306 does not include fraudulent data. In an embodiment, configuration file 308 may be an Extensible Markup Language (XML) file, and Excel file, a text file, or another type of file. In an embodiment, configuration file 308 may be configured by quality assurance or risk administrator.

In an embodiment, test case data 310 may be data that validation module 202 uses to validate data elements in request 306. Test case data 310 may include expected data that may be received or acted on by services 206. In an embodiment, test case data 310 may be data that validation module 202 presumes to be correct data. In a further embodiment, test case data may be stored in a test file, which may be in Excel or another type of format.

In an embodiment, test case data 310 may be associated with a test case ID 312. Validation module 202 may use the test case ID 312 to identify test case data 310 that is specific to request 306. In a further embodiment, a link to the location of test case data 310 or test file may be stored in the configuration file 308 at a location that is associated with test case ID 312.

In an embodiment, test case ID 312 may be one of the data elements included in request 306. In this case, when validation module 202 receives request 306, validation module 306 identifies the data element in request 306 that is designated as the test case ID 312 in the configuration file 308 and identifies rules 314 and test case data 310 that correspond to the test case ID 312. In this way, validation module 202 may be configured to validate data from different services 206 without adding code to services 206 or validation module 202, or modifying request 306. Instead, validation module 202 may use configuration file 308 configured to use one of the data elements in request 306 as the test case ID 312, and then access rules 314 and test case data 310 based on the test case ID 312. In another embodiment, test case ID 312 may be a combination of multiple data elements in request 306.

When validation module 202 receives request 306, validation module 202 passes request 306 to a test case identification module 316. The test case identification module 316 may access configuration file 308 and identify test case ID 312. The test case identification module 316 may then determine whether request 306 includes the data element(s) that correspond to the test case ID 312. For example, test case identification module 316 may parse request 306 to determine available data elements and match the data element(s) to test case ID 312. In an embodiment, when test case identification module 316 identifies the data element(s) that correspond to test case ID 312 in request 306, test case identification module 316 passes request 306 to a validator 318. When test case identification module 316 does not identify the data element(s) in request 306 that correspond to the test case ID 312, test case identification module 316 may pass request 306 to the service application layer 304.

In an embodiment, validator 318 validates request 306 against test case data 310 that is associated with test case ID 312. For example, validator 318 may validate whether content and type of data elements in request 306 corresponds to the test case data 310. In another example, validator 318 may validate whether data elements are missing from request 306. In another embodiment, validator 318 may use rules 314 in the configuration file 308 that correspond to test case ID 312 to validate values of one or more data elements in request 306 against test case data 310.

In an embodiment, validator 318 issues a validation message 320. The validation message 320 may store data which indicates whether validation was a success as shown in validation message 320A or a failure as shown in validation message 320B. Additionally, validation message 320 may also include one or more data elements that caused the validation of request 306 to fail, and also a reason for the failure. The validation module 202 may transmit the validation message 320 to a service response dispatcher 322.

In an embodiment, the service response dispatcher 322 may transmit data from validation module 202 and service application layer 204. For example, service response dispatcher 322 may transmit flow 204 that has been processed by service 206 to another service or to one of applications 108, 110, or 112. In another example, service response dispatcher 322 may transmit validation message 320 for display to a display screen of a computing device of a risk or a quality assurance administrator.

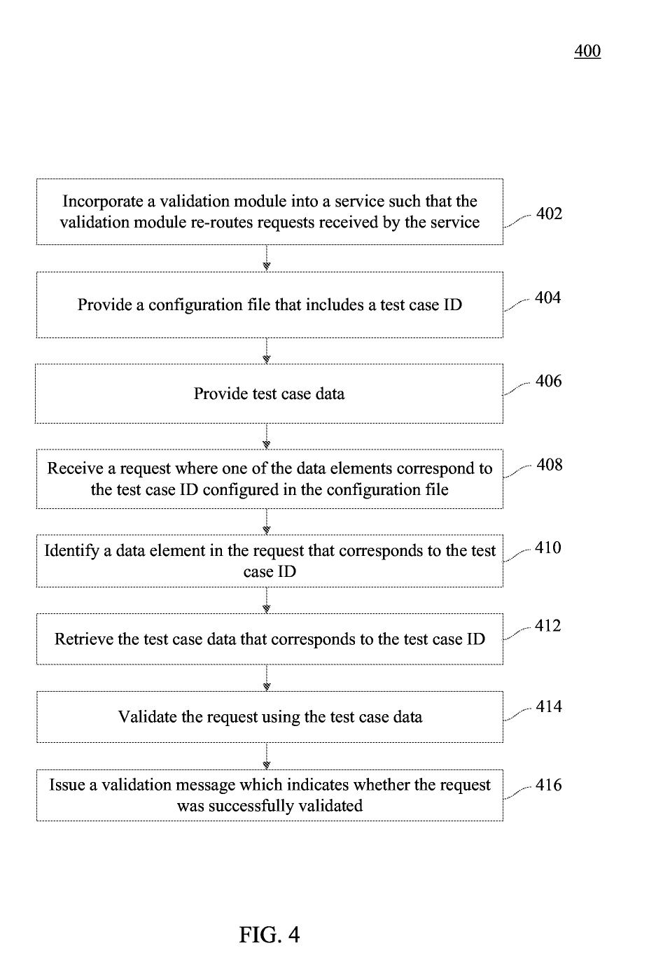

FIG. 4 is a flowchart of a method 400 for validating data, according to an embodiment. Method 400 may be performed using hardware and/or software components described in FIGS. 1-3. Note that one or more of the operations may be deleted, combined, or performed in a different order as appropriate.

At operation 402, a validation module is incorporated into a service. For example, validation module 202 may be “plugged” into service 206 that receives flow 204. As discussed above, validation module 202 may be a single solution module that may be incorporated into multiple services 206 and may validate data elements in flow 204 that may be modified by services 206 or that may include fraudulent data. As also discussed above, validation module 202 may be incorporated between the service request handler 302 and service application layer 304 of service 206.

At operation 404, a configuration file is provided. For example, configuration file 308 is provided to validation module 202. As discussed above, configuration file 308 includes test case ID 312 that may identify a test scenario and that may map to one of data elements in request 306. As also discussed above, configuration file 308 may have one or more rules 314 associated with the test case ID 312 that may be used to validate data in request 306.

At operation 406, test case data is provided. For example, test case data 310 is provided to the validation module 202. As discussed above, test case data 310 is associated with test case ID 312 and may be used to validate data that is generated or received by service 206.

At operation 408, a request is received. For example, validation module 202 receives request 306 that includes data elements. As discussed above, data elements store data that may be validated by the validation module 202. In a further embodiment, one or more data elements in request 306 may correspond to the test case ID 312 that is used to determine rules 314 and test case data 310 that validate request 306.

At operation 410, a test case ID in the request is identified. For example, test case identification module 316 of validation module 202 identifies one or more data element(s) in the request 306 that correspond to the test case ID 312 stored in the configuration file 308.

At operation 412, test case data is retrieved. For example, validator 318 retrieves test case data 310 that corresponds to the test case ID 312.

At operation 414, a request is validated according to the rules associated with the test case ID. As described above, validator 318 may validate data in request 306 using test case data 310 and rules 314.

At operation 416, a validation message is issued. For example, validation module 202 may issue validation message 320 which indicates whether validation of request 306 was a success or a failure.

Referring now to FIG. 5 an embodiment of a computer system 500 suitable for implementing, the systems and methods described in FIGS. 1-4 is illustrated.

In accordance with various embodiments of the disclosure, computer system 500, such as a computer and/or a server, includes a bus 502 or other communication mechanism for communicating information, which interconnects subsystems and components, such as a processing component 504 (e.g., processor, micro-controller, digital signal processor (DSP), graphics processing unit (GPU), etc.), a system memory component 506 (e.g., RAM), a static storage component 508 (e.g., ROM), a disk drive component 510 (e.g., magnetic or optical), a network interface component 512 (e.g., modem or Ethernet card), a display component 514 (e.g., CRT or LCD), an input component 518 (e.g., keyboard, keypad, or virtual keyboard), a cursor control component 520 (e.g., mouse, pointer, or trackball), a location determination component 522 (e.g., a Global Positioning System (GPS) device as illustrated, a cell tower triangulation device, and/or a variety of other location determination devices known in the art), and/or a camera component 523. In one implementation, the disk drive component 510 may comprise a database having one or more disk drive components.

In accordance with embodiments of the disclosure, the computer system 500 performs specific operations by the processor 504 executing one or more sequences of instructions contained in the memory component 506, such as described herein with respect to the mobile communications devices, mobile devices, and/or servers. Such instructions may be read into the system memory component 506 from another computer readable medium, such as the static storage component 508 or the disk drive component 510. In other embodiments, hard-wired circuitry may be used in place of or in combination with software instructions to implement the disclosure.

Logic may be encoded in a computer readable medium, which may refer to any medium that participates in providing instructions to the processor 504 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 510, volatile media includes dynamic memory, such as the system memory component 506, and transmission media includes coaxial cables, copper wire, and fiber optics, including wires that comprise the bus 502. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 500. In various other embodiments of the disclosure, a plurality of the computer systems 500 coupled by a communication link 524 to the network 102 (e.g., such as a LAN, WLAN, PTSN, and/or various other wired or wireless networks, including telecommunications, mobile, and cellular phone networks) may perform instruction sequences to practice the disclosure in coordination with one another.

The computer system 500 may transmit and receive messages, data, information and instructions, including one or more programs (i.e., application code) through the communication link 524 and the network interface component 512. The network interface component 512 may include an antenna, either separate or integrated, to enable transmission and reception via the communication link 524. Received program code may be executed by processor 504 as received and/or stored in disk drive component 510 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A system, comprising:
a non-transitory memory storing instructions; and
one or more hardware processors coupled to the non-transitory memory and configured to read the instructions from the non-transitory memory to cause the system to perform operations comprising:
incorporating a validation module into a service;
providing a configuration file, wherein the configuration file includes a test case identifier;
providing test case data that corresponds to the test case identifier;
receiving a request for the service, wherein the request includes a plurality of data elements that the service uses to process the request;
identifying a data element from the plurality of data elements in the request that corresponds to the test case identifier in the configuration file; and
validating the request using the test case data that corresponds to the test case identifier based on the identifying.

2. The system of claim 1, wherein the operations further comprise:
re-routing the request from the service, wherein the re-routed request is validated using the validation module.

3. The system of claim 1, wherein the configuration file includes a plurality of rules associated with the test case identifier.

4. The system of claim 3, wherein the operations further comprise:
validating the request using the test case data and the plurality of rules.

5. The system of claim 1, wherein the operations for incorporating the validation module further comprise:
plugging the validation module into the service.

6. The system of claim 1, wherein at least one component of the validation module is generated using Aspect Oriented Programming (AOP).

7. The system of claim 1, wherein the operations further comprise:
generating a validation message, wherein the validation message indicates success or failure of validation.

8. The system of claim 1, wherein the operations that identify the data element, further comprise identifying a first data element and a second data element from the plurality of data elements, wherein the first data element and the second data element correspond to the test case identifier, wherein the first data element and the second data element store data that is processed by the service.

9. A method, comprising:
incorporating a validation module into a service configured to operate on a computing device;
providing a configuration file, wherein the configuration file includes a test case identifier;
providing test case data that corresponds to the test case identifier;
receiving a request for the service, wherein the request includes a plurality of data elements that the service uses to process the request;
identifying a data element from the plurality of data elements in the request that corresponds to the test case identifier in the configuration file; and
validating the request using the test case data that corresponds to the test case identifier based on the identifying.

10. The method of claim 9, further comprising:
re-routing the request from the service, wherein the re-routing request is validated using the validation module.

11. The method of claim 9, wherein the configuration file includes a plurality of rules associated with the test case identifier.

12. The method of claim 9, further comprising:
validating the request using the test case data and the plurality of rules.

13. The method of claim 9, wherein the incorporating further comprises:
plugging the validation module into the service.

14. The method of claim 9, wherein at least one component of the validation module is generated using Aspect Oriented Programming (AOP).

15. A system, comprising:
a non-transitory memory storing instructions; and
one or more hardware processors coupled to the non-transitory memory and configured to read the instructions from the non-transitory memory to cause the system to perform operations comprising:
providing test case data;
receiving a request, wherein the request includes a plurality of data elements that a service uses to process the request;
re-routing the request to a validation module plugged into the service between a service request handler and a service application layer;
identifying, using the validation module, a data element from the plurality of data elements in the request that corresponds to a test case identifier in a configuration file; and
validating, using the validation module, the request using the test case data and a plurality of rules from the configuration file.

16. The system of claim 15, wherein the validation module is a single validation solution for multiple services.

17. The system of claim 15, wherein the request includes data for a transaction associated with the service.

18. The system of claim 17, wherein the validation module validates whether the data in the request is fraudulent data.

19. The system of claim 15, wherein at least one component of the validation module is generated using Aspect Oriented Programming (AOP).

20. The system of claim 15, wherein the operations further comprise:
generating a validation message, wherein the validation message indicates a reason for the request failing validation.
